(19) United States
(12) Patent Application Publication
(10) Pub. No.: US 2011/0241601 A1
(43) Pub. Date: Oct. 6, 2011

(54) RECHARGING DEVICE WHICH ILLUMINATES BY SOLAR ENERGY

(76) Inventor: Sheng-Chun Lin, Yonghe City (TW)

(21) Appl. No.: 12/753,975

(22) Filed: Apr. 5, 2010

(51) Int. Cl. H01M 10/46

(52) U.S. Cl. 320/101

(57) ABSTRACT

A recharging device which illuminates by solar energy includes at least a housing in a predetermined special shape. The housing contains a circuit substrate which is electrically connected with a solar energy panel and an accumulator device, an illumination element, a sensor unit module, a recharging stand as well as a photocatalytic sterilization unit which are electrically connected with the circuit substrate; whereas, the circuit substrate is also electrically connected with an external surveillance camera unit and an external recharging stand. Therefore, the recharging device is not only able to recharge an electronic product, but also able to be provided with technical functions of detecting parameters including static, ultraviolet, air pollution, and humiture. In addition, by detecting the different parameters, the illumination element can change brightness or color of a light source.

### BACKGROUND OF THE INVENTION

a) Field of the Invention The present invention relates to a device having illumination and recharging effects and more particularly to a recharging device which illuminates by solar energy, wherein the device is provided with a very special appearance so as to be combined with nature or all kinds of landscapes, and in a mean time, conducts illumination, recharging, storing of electricity, several kinds of alerting functions and surveillance by solar energy.

b) Description of the Prior Art

Among all kinds of alternative energy sources, solar energy is most representative, as the solar energy can not only be used on vehicles, but also be employed in power systems to generate electricity. In addition, the solar energy can be used forever, is pretty, environmental friendly and very practical. To utilize the solar energy, a device, which is called a solar energy device, is formed through integration. The solar energy device absorbs sunlight through a solar energy chip and converts the absorbed sunlight into electric energy. Therefore, the sunlight can be converted into electricity for output.

However, when using the aforementioned solar energy device, following issues and shortcomings actually exist to be improved.

Although being provided with a function of collecting the solar energy and achieving the effect of generating electricity by the solar energy, the appearance of an ordinary solar energy device is very dull and is in lack of some daily functions upon applying the solar energy, such as converting the solar energy for use on a recharger and at a same time, having the special appearance. All these are the features that cannot be achieved by the ordinary solar energy devices now.

### SUMMARY OF THE INVENTION

The primary object of the present invention is to provide a recharging device which illuminates by solar energy, wherein the recharging device includes at least a housing in a predetermined special shape (animal or plant) and an interior of the housing is accommodated with a circuit substrate which is electrically connected with at least an illumination element, at least a solar energy panel and a sensor unit module. The sensor unit module contains a static sensor unit, an ultraviolet sensor unit, an air pollution sensor unit and a humiture sensor unit, such that after the solar energy panels have absorbed solar energy from a light source of solar energy and converted the solar energy into a power source to be stored in an accumulator device, an electronic product can be recharged through the accumulator device. In addition, static, ultraviolet, air pollution and humiture can be detected through the sensor unit module. When the static sensor unit detects a crisis of static, the illumination element will change color to remind people; if the ultraviolet sensor unit has detected that the ultraviolet is too strong that a crisis is available, then the illumination element will change color to remind people; if the air pollution sensor unit has detected that air is polluted, then the illumination element will change color to remind people; and if the humiture sensor unit has detected that humidity is abnormal, then the illumination element will change color to remind people. By the aforementioned technologies, the issues and shortcomings existing in the conventional solar energy device that although the solar energy device is provided with the function of collecting the solar energy and can achieve the effect of generating electricity by the solar energy, the appearance of the ordinary solar energy device is very dull and is in lack of daily functions upon applying the solar energy, such as converting the solar energy for use on the recharger and in a mean time, having the special appearance, which are all the features that the ordinary solar energy device cannot achieve, can be solved, thereby achieving practical progressiveness by the recharging device having the housing in a special novelty shape, with that the electric energy can be stored to supply the necessary electricity to the illumination element and the sensor unit module, through the accumulator device, enabling the illumination element to change brightness and color of the light source by values detected by the sensor set module to remind people.

Another object of the present invention is to provide a recharging device which illuminates by solar energy, wherein an interior of the housing is accommodated with a circuit substrate, a recharging stand which is electrically connected with the circuit substrate, a photocatalytic sterilization unit and a surveillance camera unit which are electrically connected with the circuit substrate, such that when a user is to recharge an electronic product, the electronic product can be recharged through the recharging stand and in a same time, the electronic product can be sterilized by the photocatalytic sterilization unit.

On the other hand, areal monitoring to images of people or vehicles passing through can be also conducted through the surveillance camera unit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of the preferred embodiment of the present invention.

FIG. 3 shows a block diagram of the preferred embodiment of the present invention.

FIG. 4 shows a first schematic view of an outdoor implementation of the preferred embodiment of the present invention.

FIG. 5 shows a second schematic view of the outdoor implementation of the preferred embodiment of the present invention.

FIG. 6 shows a schematic view of an indoor implementation of the preferred embodiment of the present invention.

FIG. 7 shows a schematic view of an implementation of a first preferred embodiment of the present invention.

FIG. 8 shows a schematic view of an implementation of a second preferred embodiment of the present invention.

FIG. 9 shows a schematic view of an implementation of a third preferred embodiment of the present invention.

FIG. 10 shows a schematic view of an implementation of a fourth preferred embodiment of the present invention.

FIG. 11 shows a schematic view of an implementation of a fifth preferred embodiment of the present invention.

FIG. 12 shows a schematic view of an implementation of a sixth preferred embodiment of the present invention.

FIG. 13 shows a schematic view of an implementation of a seventh preferred embodiment of the present invention.

FIG. 14 shows a schematic view of an implementation of an eighth preferred embodiment of the present invention.

FIG. 15 shows a schematic view of an implementation of a ninth preferred embodiment of the present invention.

FIG. 16 shows a schematic view of an implementation of a tenth preferred embodiment of the present invention.

FIG. 17 schematic view of an implementation of an eleventh preferred embodiment of the present invention.

### DETAILED DESCRIPTION OF THE PREFERRED EMBODIMENTS

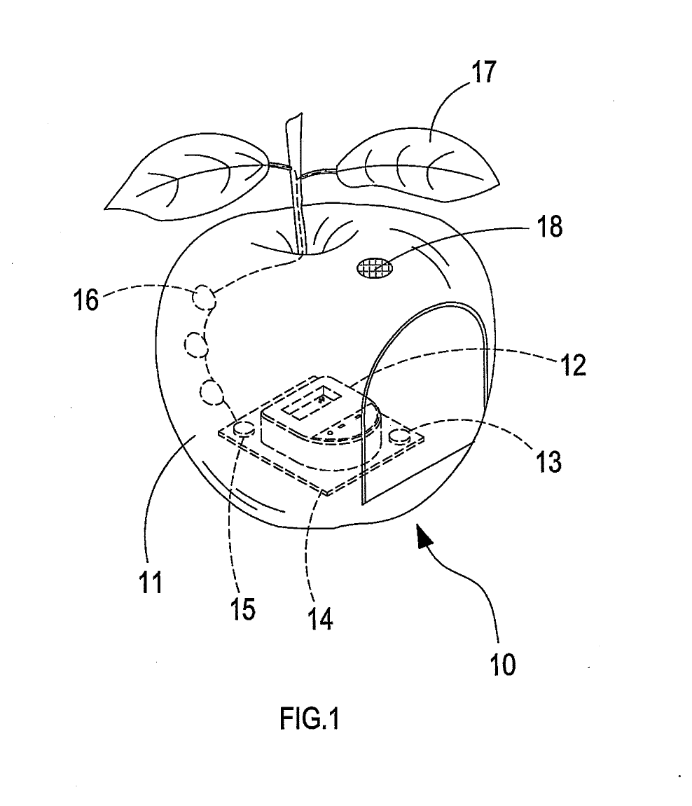

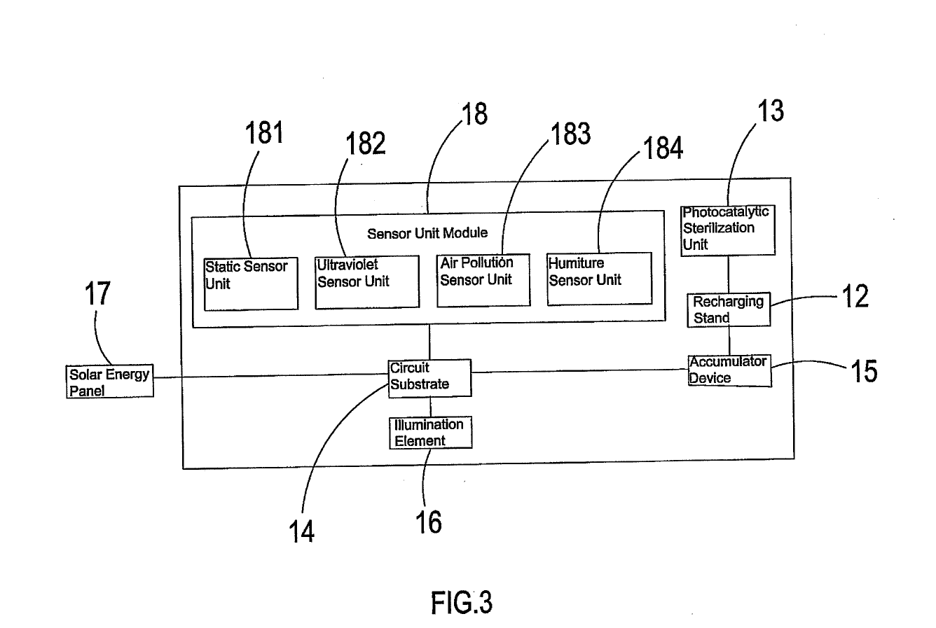

Referring to FIGS. 1 to 3, it shows a three-dimensional view, an exploded view and a block diagram, of a preferred embodiment of the present invention. As shown in the drawings, a recharging device 10, according to the present invention, comprises at least a housing 11 in a predetermined special shape which is an animal or a plant. An interior of the housing 11 is further accommodated with a recharging stand 12 which is electrically connected with an accumulator device 15 described hereinafter and a photocatalytic sterilization unit 13 which is electrically connected a circuit substrate 14 described hereinafter. The primary characteristics of the recharging device 10 include the circuit substrate 14, which is accommodated in the housing 11 and is electrically connected with at least one accumulator device 15; at least an illumination element 16, which is accommodated in the housing 11 and is electrically connected with the circuit substrate 14; at least a solar energy panel 17, which is electrically connected with the circuit substrate 14 to absorb solar energy; and a sensor unit module 18, which is electrically connected with the circuit substrate 14 and includes a static sensor unit 181, an ultraviolet sensor unit 182, an air pollution sensor unit 183 and a humiture sensor unit 184.

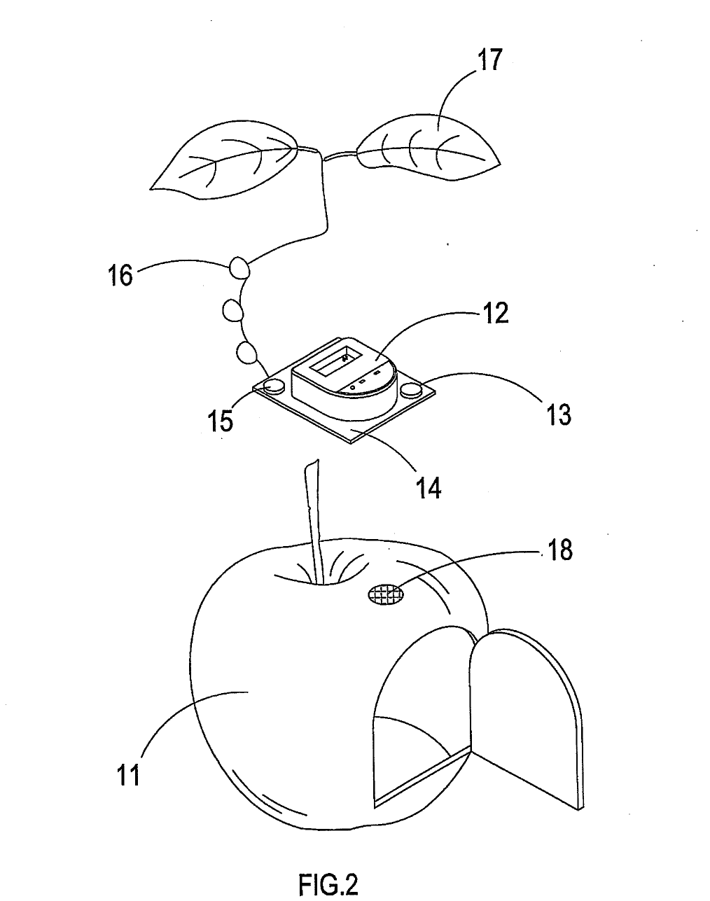

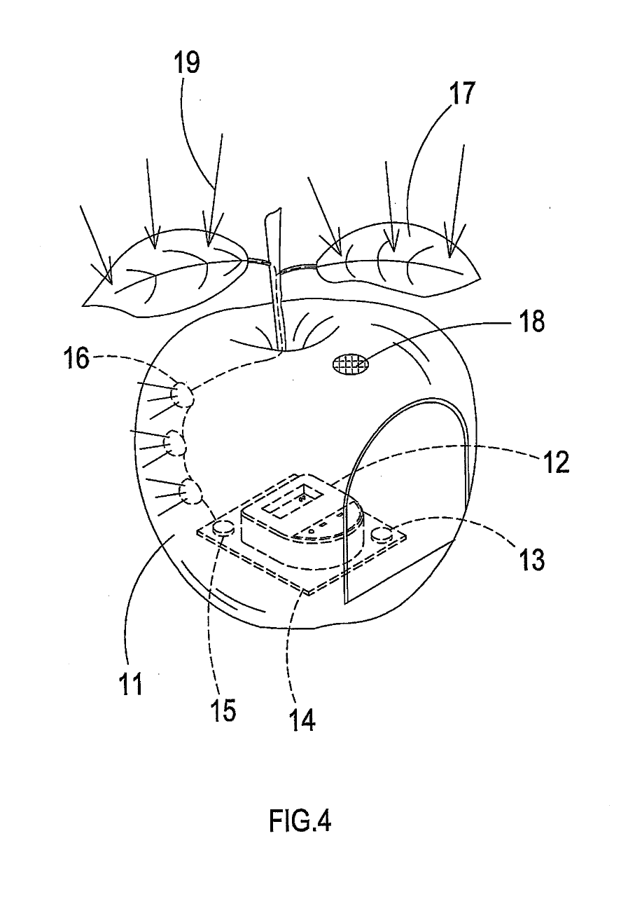

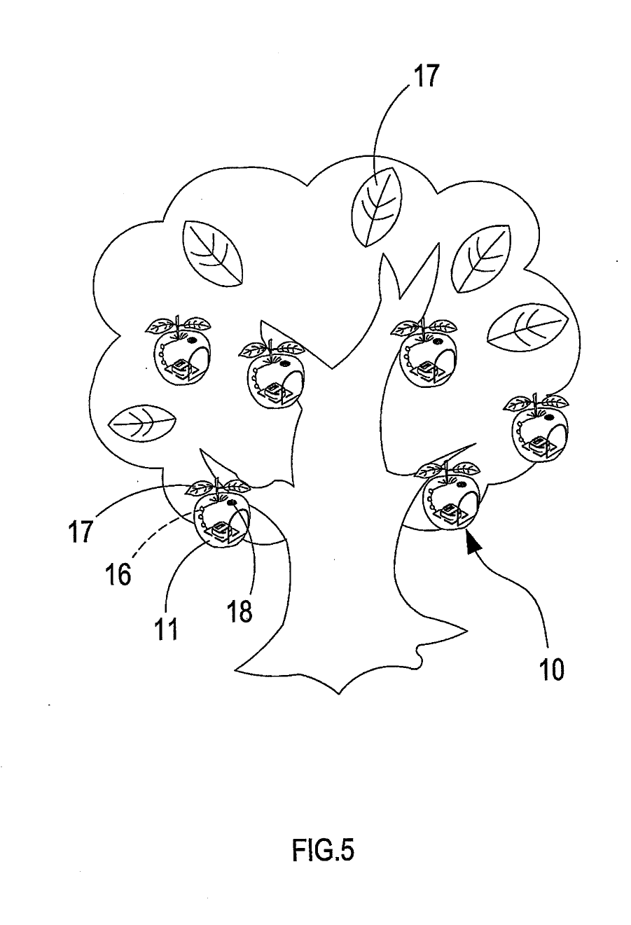

Referring to FIGS. 2 to 5, it shows the exploded view, the block diagram, a first schematic view of an outdoor implementation and a second schematic view of the outdoor implementation, of the preferred embodiment of the present invention. As shown in the drawings, the solar energy panel 17 absorbs solar energy from a light source 19 of the solar energy and converts the solar energy into a power source to be stored in the accumulator device 15, followed by supplying electricity to the sensor unit module 18 or the illumination element 16 and detecting static, ultraviolet, air pollution, humiture through the sensor unit module 18. When the static sensor unit 181 detects a crisis of static, the illumination element 16 will change color to remind people that static nearby is too strong and weather is too dry that approaching is not recommended; if the ultraviolet sensor unit 182 has detected that ultraviolet is too strong that a crisis is available, then the illumination element 16 will change color to remind people to keep away from sunlight and stay indoors; if the air pollution sensor unit 183 has detected that air is polluted, then the illumination element 16 will change color to remind people that air quality is too bad; and if the humiture sensor unit 184 has detected that humidity is abnormal, then the illumination element 16 will change color to remind people.

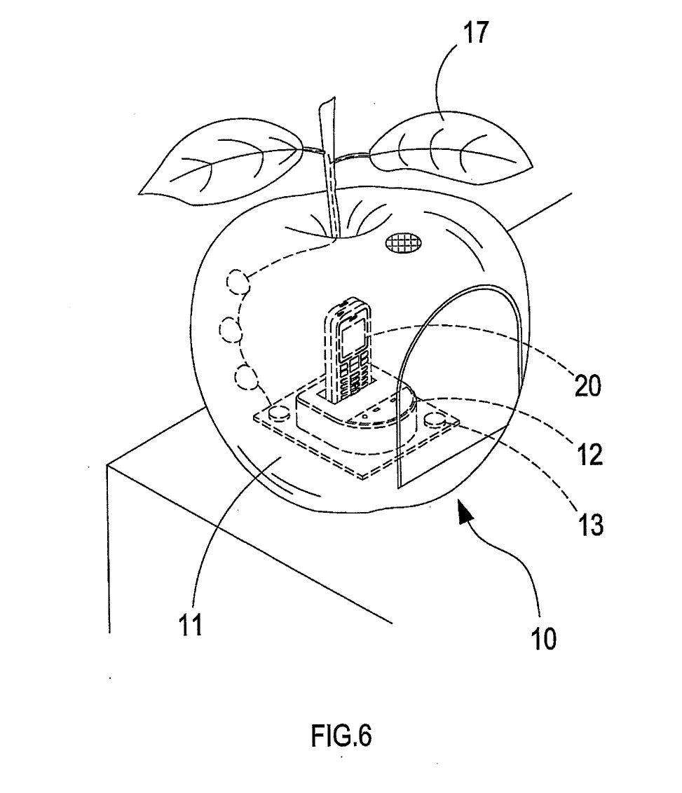

Referring to FIG. 6, it shows a schematic view of an indoor implementation of the preferred embodiment of the present invention. As shown in the drawing, the recharging device 10 is provided with at least one housing 11 in a predetermined special shape and can be emplaced indoors. The recharging device 10 includes a recharging stand 12 for combining with an electronic product 20. After a user has combined the electronic product 20 with the recharging stand 12, the combined device can be used for a loudspeaker of music, a message player, an alarm clock or a snoring alarm clock, with an extremely broad application. In a mean time, a sterilization function can be conducted to the electronic product 20 through the photocatalytic sterilization unit 13.

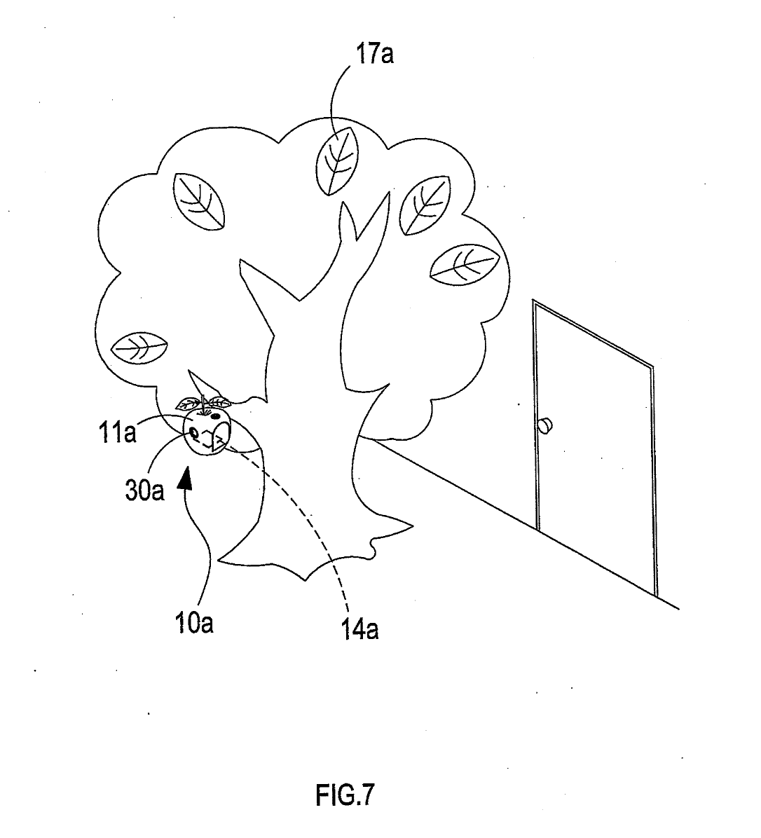

Referring to FIG. 7, it shows a schematic view of an implementation of a first preferred embodiment of the present invention. As shown in the drawing, a recharging device 10a is provided with at least a housing 11a in a predetermined special shape. An interior of the housing 11a is accommodated with a circuit substrate 14a which is further electrically connected with a surveillance camera unit 30a, allowing the surveillance camera unit 30a to be also provided with a disguise effect. Furthermore, through the surveillance camera unit 30a, indoor or outdoor conditions can be monitored at any time and daily conditions can be recorded to be watched by the user.

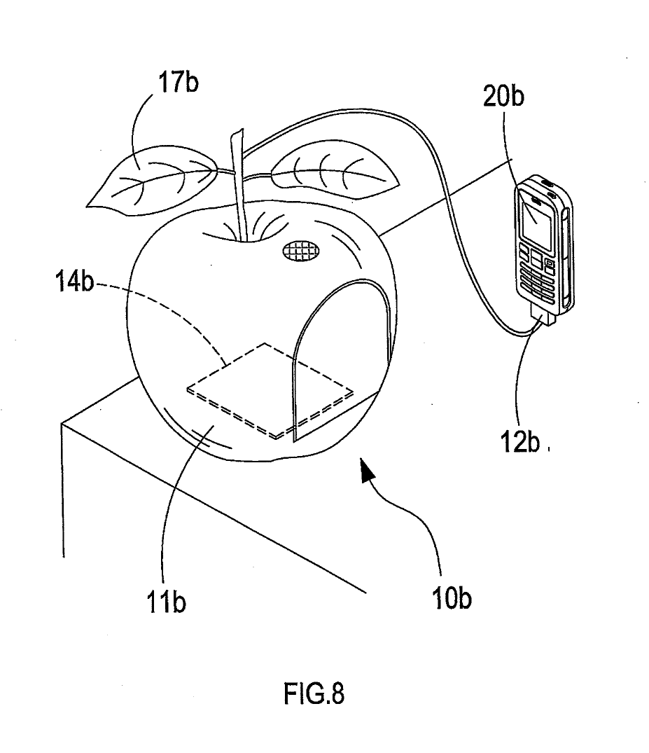

Referring to FIG. 8, it shows a schematic view of an implementation of a second preferred embodiment of the present invention. As shown in the drawing, a recharging device 10b is provided with at least a housing 11b in a predetermined special shape. An interior of the housing 11b is accommodated with a circuit substrate 14b which is further electrically connected with an external recharging stand 12b, allowing the user to directly use the external recharging stand 12b to recharge the electronic product 20b, which facilitates the user.

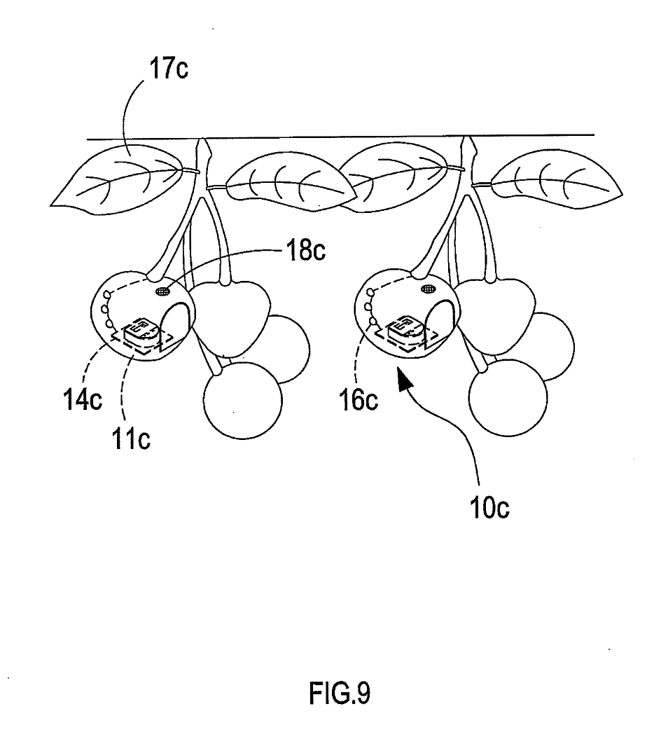

Referring to FIG. 9, it shows a schematic view of an implementation of a third preferred embodiment of the present invention. As shown in the drawing, a recharging device 10c is provided with at least a housing 11c in a predetermined special shape. An interior of the housing 11c is provided with an illumination element 16c and a sensor unit module 18c which are electrically connected with a circuit substrate 14c. Besides, the housing 11c can be in a shape of grapes, i.e., a kind of food. However, the present invention is not limited to the shape of the grapes, which is only one embodiment. In fact, all the appearances of foods are claimed by the present invention.

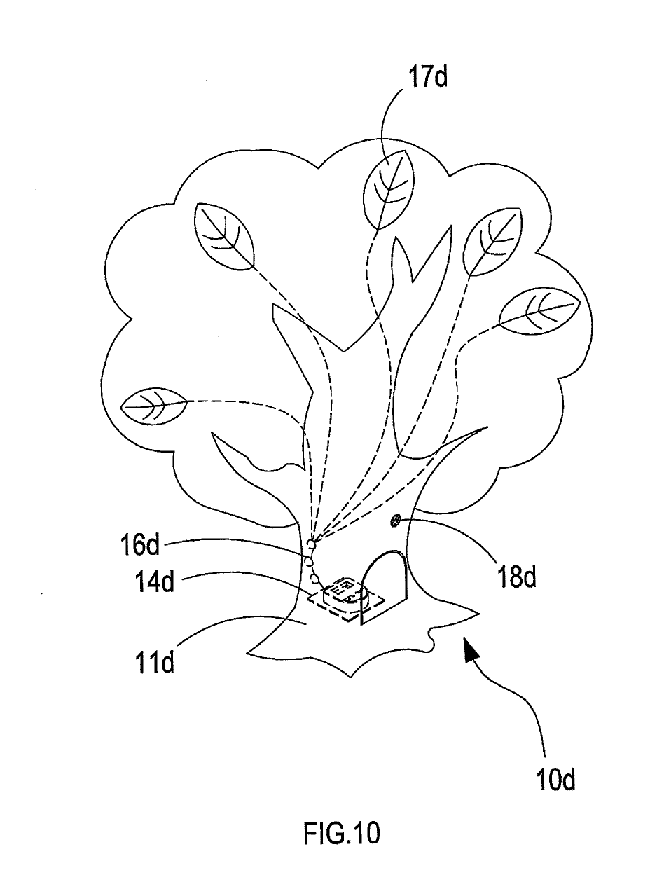

Referring to FIG. 10, it shows a schematic view of an implementation of a fourth preferred embodiment of the present invention. As shown in the drawing, a recharging device 10d is provided with at least a housing 11d in a predetermined special shape. An interior of the housing 11d is provided with an illumination element 16d and a sensor unit module 18d which are electrically connected with a circuit substrate 14d. Besides, the housing 11d can be in a shape of a tree, i.e., a plant. However, the present invention is not limited to the shape of the tree, which is only one embodiment. In fact, all the appearances of plants are claimed by the present invention.

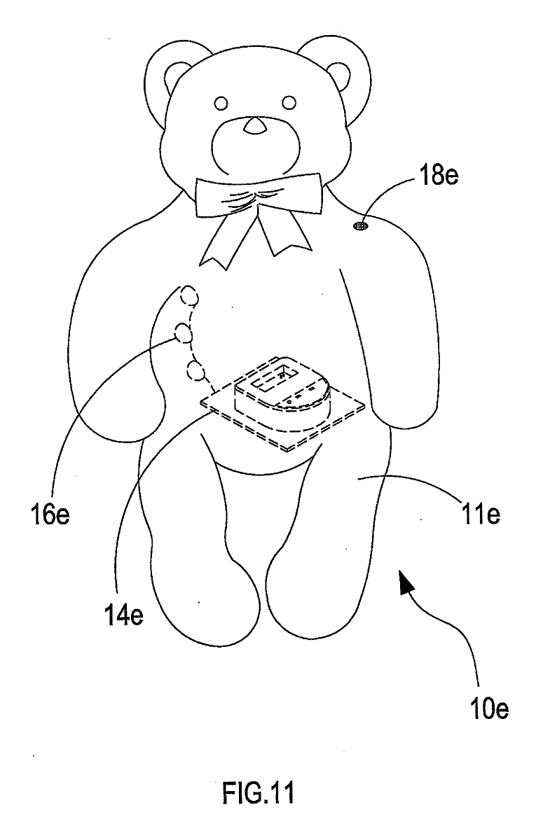

Referring to FIG. 11, it shows a schematic view of an implementation of a fifth preferred embodiment of the present invention. As shown in the drawing, a recharging device 10e is provided with at least a housing 11e in a predetermined special shape. An interior of the housing 11e is provided with an illumination element 16e and a sensor unit module 18e which are electrically connected with a circuit substrate 14e. Besides, the housing 11e can be in a shape of a cub, i.e., an animal. However, the present invention is not limited to the shape of the cub, which is only one embodiment. In fact, all the appearances of animals are claimed by the present invention.

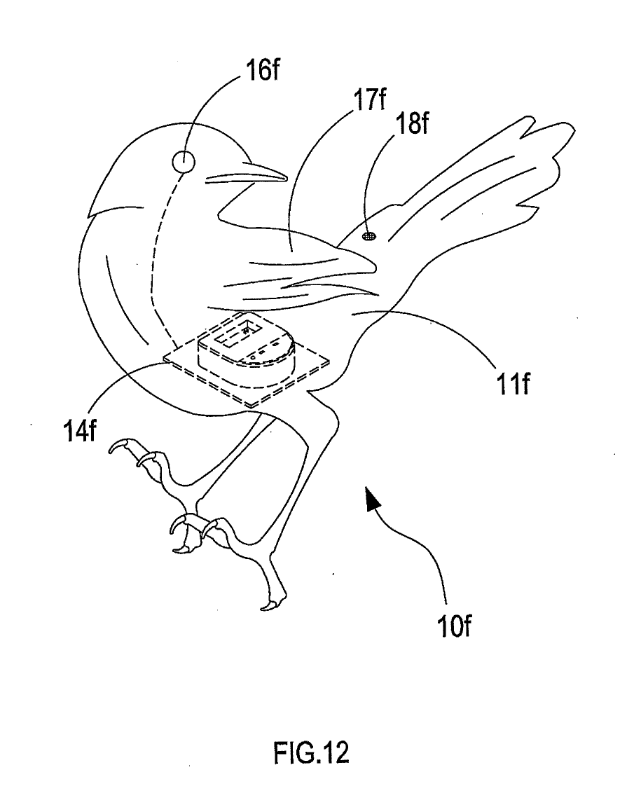

Referring to FIG. 12, it shows a schematic view of an implementation of a sixth preferred embodiment of the present invention. As shown in the drawing, a recharging device 10f is provided with at least a housing 11f in a predetermined special shape. An interior of the housing 11f is provided with an illumination element 16f and a sensor unit module 18f which are electrically connected with a circuit substrate 14f. Besides, the housing 11f can be in a shape of a birdie, i.e., an animal. However, the present invention is not limited to the shape of the birdie, which is only one embodiment. In fact, all the appearances of animals are claimed by the present invention.

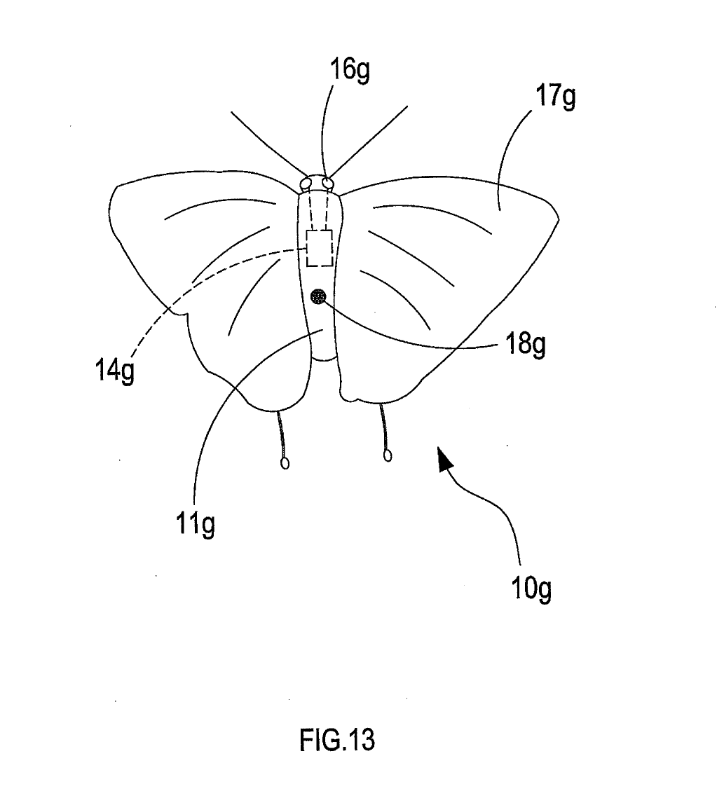

Referring to FIG. 13, it shows a schematic view of an implementation of a seventh preferred embodiment of the present invention. As shown in the drawing, a recharging device 10g is provided with at least a housing 11g in a predetermined special shape. An interior of the housing 11g is provided with an illumination element 16g and a sensor unit module 18g which are electrically connected with a circuit substrate 14g. Besides, the housing 11g can be in a shape of a butterfly, i.e., an animal. However, the present invention is not limited to the shape of the butterfly, which is only one embodiment. In fact, all the appearances of animals are claimed by the present invention.

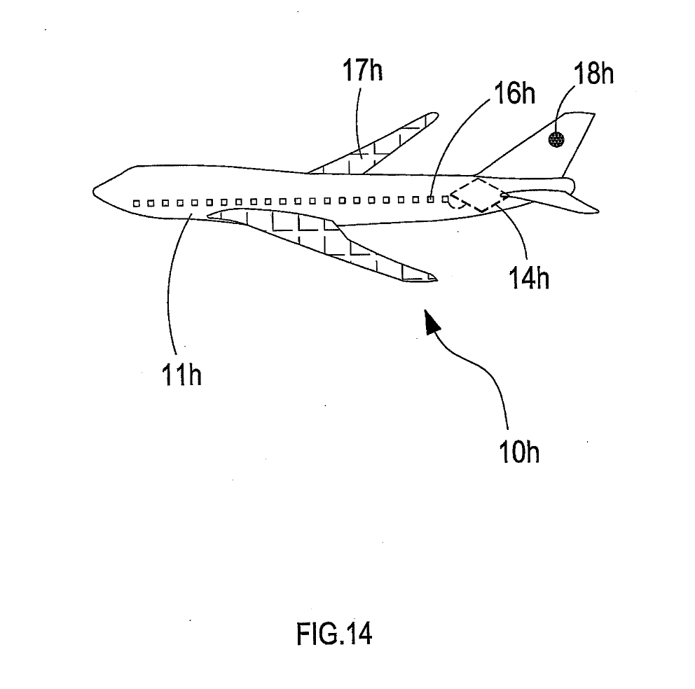

Referring to FIG. 14, it shows a schematic view of an implementation of an eighth preferred embodiment of the present invention. As shown in the drawing, a recharging device 10h is provided with at least a housing 11h in a predetermined special shape. An interior of the housing 11h is provided with an illumination element 16h and a sensor unit module 18h which are electrically connected with a circuit substrate 14h. Besides, the housing 11h can be in a shape of an airplane and wings of the airplane are provided with solar energy panels 17h which are electrically connected with the recharging device 10h.

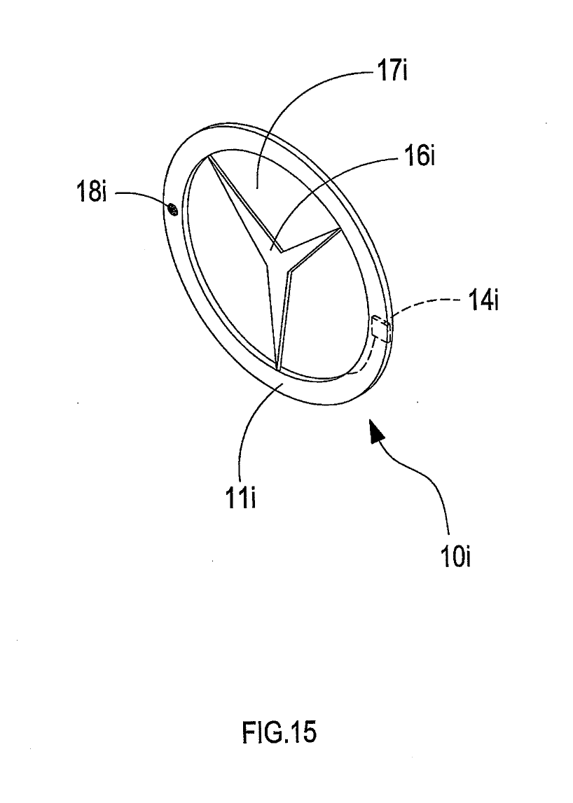

Referring to FIG. 15, it shows a schematic view of an implementation of a ninth preferred embodiment of the present invention. As shown in the drawing, a recharging device 10i is provided with at least a housing 11i in a predetermined special shape. An interior of the housing 11i is provided with an illumination element 16i and a sensor unit module 18i which are electrically connected with a circuit substrate 14i. Besides, the housing 11i can be in a shape of a chevron and a bottom of the chevron is provided with a solar energy panel 17i which is electrically connected with the recharging device 10i; the recharging device 10i can be used on a vehicle to serve as an uninterruptable illumination device.

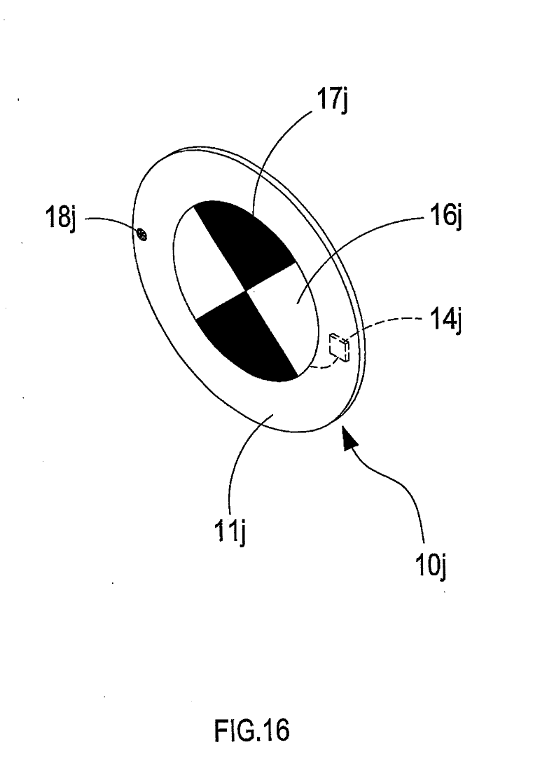

Referring to FIG. 16, it shows a schematic view of an implementation of a tenth preferred embodiment of the present invention. As shown in the drawing, a recharging device 10j is provided with at least a housing 11j in a predetermined special shape. An interior of the housing 11j is provided with an illumination element 16j and a sensor unit module 18j which are electrically connected with a circuit substrate 14j. Besides, the housing 11j can be in a shape of a continuous fan, an interior of the predetermined fan is provided with a solar energy panel 17j which is electrically connected with the recharging device 10j and is accommodated with the aforementioned illumination element 16j; the recharging device 10j can be used on a vehicle to serve as an uninterruptable illumination device.

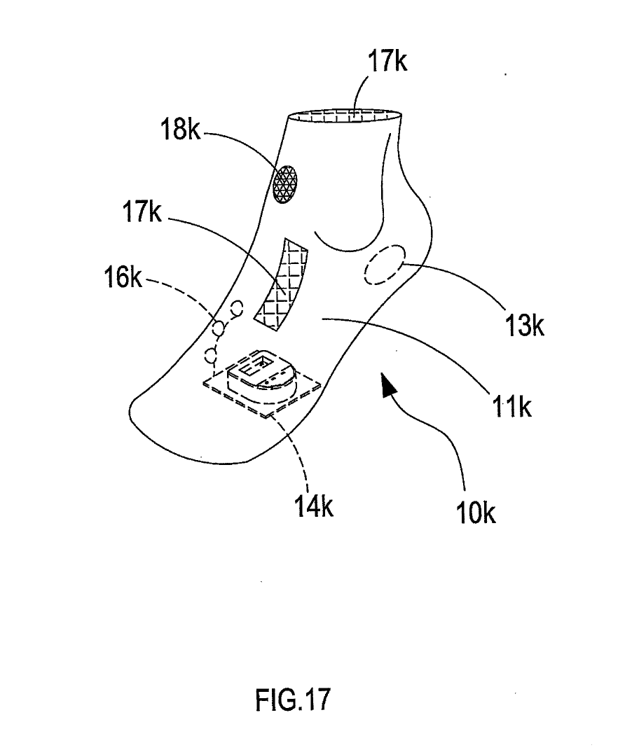

Referring to FIG. 17, it shows a schematic view of an implementation of an eleventh preferred embodiment of the present invention. As shown in the drawing, a recharging device 10k is provided with at least a housing 11k in a predetermined special shape. An interior of the housing 11k is provided with an illumination element 16k, a sensor unit module 18k and a photocatalytic sterilization unit 13k which are electrically connected with a circuit substrate 14k. Besides, the housing 11k can be in a shape of a foot and can be put in a shoe so that sterilization can be conducted inside the shoe through the photocatalytic sterilization unit 13k. In addition, upper parts of the foot are provided with solar energy panels 17k which are electrically connected with the recharging device 10k.

Accordingly, the present invention is indeed provided with following advantages.

The present invention is provided with practical progressiveness by that the housing 11 is in a special novelty shape (such as an animal, a plant or a food) and electric energy can be stored through the accumulator device 15 to supply necessary electricity to the illumination element 16 and the sensor unit module 18, such that the illumination element 16 can carry out the change of brightness or color to the light source, by values (static, ultraviolet, air pollution and humiture) detected by the sensor unit module 18, to remind people.

On the other hand, recharging can be conducted to the electronic product 20. For example, a cell phone can be accommodated in the housing 11 and combined with the recharging stand 12 to recharge by converting the solar energy into the electric energy. The cell phone can also act as a loudspeaker of music, a snoring alarm clock and an alarm clock.

Moreover, people and vehicles outdoor can be also monitored by the surveillance camera unit 30a, thereby achieving double protection to a residence.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A recharging device which illuminates by solar energy, comprising at least one housing in a pre-determined special shape, with primary characteristics including:
a circuit substrate which is accommodated in the housing and is electrically connected with at least an accumulator device;
at least an illumination element which is accommodated in the housing and is electrically connected with the circuit substrate;
at least a solar energy panel which is electrically connected with the circuit substrate to absorb solar energy; and
a sensor unit module which is electrically connected with the circuit substrate.

2. The recharging device which illuminates by solar energy according to claim 1, wherein an interior of the housing is further accommodated with a recharging stand which is electrically connected with the accumulator device.

3. The recharging device which illuminates by solar energy according to claim 1, wherein an interior of the housing is further accommodated with a photocatalytic sterilization unit which is electrically connected with the circuit substrate.

4. The recharging device which illuminates by solar energy according to claim 1, wherein the sensor unit module includes a static sensor unit, an ultraviolet sensor unit, an air pollution sensor unit and a humiture sensor unit.

5. The recharging device which illuminates by solar energy according to claim 1, wherein the circuit substrate is further electrically connected with a surveillance camera unit.

6. The recharging device which illuminates by solar energy according to claim 1, wherein the circuit substrate is further electrically connected with an external recharging stand.

7. The recharging device which illuminates by solar energy according to claim 1, wherein the housing is in a shape of an animal, a plant, a food, an airplane, a chevron, a continuous fan and a foot.
